(19) United States
(12) Patent Application Publication
(10) Pub. No.: US 2026/0238499 A1
(43) Pub. Date: Aug. 13, 2026

(54) 24HWS Human Sovereign Mobile Terminal System for Global Time-Value Economy and Decentralized Governance

(71) Applicant: FURONG BEI, SAN GABRIEL, CA (US)

(72) Inventor: FURONG BEI, SAN GABRIEL, CA (US)

(21) Appl. No.: 19/096,717

(22) Filed: Apr. 1, 2025

(51) Int. Cl. H04L 9/32; G06Q 20/40; H04L 9/00

(52) U.S. Cl. CPC H04L 9/3297; G06Q 20/40145; H04L 9/50

(57) ABSTRACT

A BEI Sovereign Mobile Terminal integrates multimodal acquisition, BEI identity anchoring, MemoryChain recording, TimeCurrency mint-trigger generation, Retrochain forensic remediation, Relay Mesh communication, and domain-based endpoint routing. The terminal acquires physiological, behavioral, device-context, or environmental signals, validates quality and liveness using an acquisition gate, binds an accepted event to a BEI identity anchor, and records a cryptographic commitment in MemoryChain. A TimeCurrency engine verifies policy, validity-window, and anti-replay states before generating a mint certificate. A Retrochain module detects anomalies and produces forensic remediation receipts for quarantine, freeze, rollback, release, or restoration. A Relay Mesh routes emergency or recovery messages during degraded connectivity. A namespace resolver verifies signed endpoint records for identity, minting, currency, clearing exchange, index, operating-system, signature, standards, medical, governance, regulatory, or emergency services.

### CROSS-REFERENCE TO RELATED APPLICATIONS

This application is related to one or more patent applications and ecosystem filings directed to Behavioral Economics Identity (BEI), BEI decentralized identity, BEI electronic or economic identity, ATMS, 24HWS, TimeCurrency, BEIMINT, BEICurrency, BEIGX, BEICX, BEISX, BEIINDEX, BEIECO, BEISOS, domain-based namespace routing, MemoryChain recording, Retrochain or FR2-style forensic remediation, and related sovereign digital infrastructure. To the extent any priority claim is intended, such priority claim is identified in the accompanying Application Data Sheet (ADS). References herein to related applications, systems, domains, or ecosystem filings are provided as technical context and non-limiting implementation support and shall not be construed as an admission of prior art or as limiting the scope of the present disclosure.

### STATEMENT REGARDING DOMAIN-BASED NAMESPACE RESOURCES

In certain embodiments, the BEI Sovereign Mobile Terminal communicates with a domain-based namespace and endpoint layer. Non-limiting examples of such namespace basepoints may include ATMS.com, BEI.app, MF.app, 24HWS.com, 36JI.com, SZBF.com, BEIECO.com, BEISOS.com, BEIMINT.com, BEICurrency.com, BEIDID.com, BEIEDI.com, BEIEID.com, TimeCurrency.app, BEIGX.com, BEICX.com, BEISX.com, BEIIndex.com, BEISign.com, BEIIP.com, medicalcenter.us, 120.us, and other identity, minting, clearing, index, operating-system, signature, medical, emergency, education, finance, manufacturing, family, country, regional, or industry-specific namespaces. These examples are illustrative only. The invention does not require any particular domain name, registry, registrar, top-level domain, server provider, blockchain, or network operator.

A domain-based namespace basepoint may operate as a resolvable identifier, service node, policy node, endpoint map, operating-system gateway, or resource-routing entry. A BEI Sovereign Mobile Terminal may resolve such a basepoint to obtain signed endpoint records for identity services, minting services, currency services, clearing services, exchange services, index services, emergency services, medical services, policy services, governance services, or resource-management services. The endpoint records may include service categories, endpoint addresses, public keys, policy versions, validity windows, jurisdiction identifiers, industry codes, currency identifiers, resource types, emergency priorities, and routing constraints.

The namespace layer may support persons, families, households, organizations, industries, institutions, countries, regions, currencies, resources, and regulatory-policy domains. In certain implementations, such namespace resources may be used to support thousands of human needs, hundreds of industries, multiple currency families, resource categories, and jurisdiction-specific policy profiles. Such scale is described as an implementation context and not as a limitation required for practicing the claimed invention.

### TECHNICAL FIELD

The present disclosure relates to mobile computing terminals, wearable and implant-assisted identity systems, biometric and behavioral signal acquisition, decentralized identity, tamper-evident event recording, time-value computation, cryptographic certificates, emergency mesh communications, forensic remediation, and domain-based endpoint routing. More particularly, the disclosure relates to a BEI Sovereign Mobile Terminal configured to operate as a personal entry node for identity-bound behavior-value accounting and mint-trigger generation in a BEI, ATMS, 24HWS, TimeCurrency, BEIMINT, BEICurrency, BEIDID, BEIEID, BEISOS, BEIGX, BEICX, BEISX, BEIINDEX, and BEIECO ecosystem.

### BACKGROUND OF THE INVENTION

Conventional mobile phones provide communication, application execution, and payment interfaces, but they generally do not provide a terminal-side closed loop that verifies physiological or behavioral events, binds those events to a persistent identity anchor, records tamper-evident event commitments, generates mint-trigger certificates for time-denominated value units, and performs forensic remediation when abnormal activity is detected.

Wearable devices and health sensors may collect physiological signals, but they frequently remain isolated from identity, value, and emergency governance workflows. Activity-reward systems may issue points or tokens, but they often rely on centralized databases and lack terminal-generated evidence receipts, cryptographic anti-replay controls, or verifiable recovery flows.

Decentralized identity systems may provide identifiers or credentials, but they often lack direct integration with multimodal physiological acquisition, real-time behavior recording, terminal-level TimeCurrency mint triggers, and emergency communication failover. Blockchain wallets may store tokens, but they generally do not determine whether a human behavior event was acquired with sufficient quality, liveness, identity confidence, and policy authorization before a mint-trigger certificate is generated.

Mesh communication systems may route messages in degraded network environments, but they are typically not bound to identity-anchored behavior-value records, forensic remediation receipts, or TimeCurrency minting state. Emergency systems may contact medical or government resources, but they often cannot prove the chain of acquisition, identity, event recording, minting, abnormality, freeze, restoration, and relay communication in a single terminal-originated workflow.

There is therefore a need for a BEI Sovereign Mobile Terminal that integrates multiple technical layers into a coordinated closed-loop workflow: multimodal acquisition, BEI identity anchoring, MemoryChain recording, TimeCurrency mint-trigger generation, Retrochain forensic remediation, and Relay Mesh emergency routing. Such a terminal can operate as a practical personal entry node for BEI, ATMS, 24HWS, BEIMINT, BEICurrency, BEIDID, BEIEID, BEISOS, BEIGX, BEICX, BEISX, BEIINDEX, BEIECO, and related domain-based endpoint networks.

### SUMMARY OF THE INVENTION

In one aspect, a BEI Sovereign Mobile Terminal includes a multimodal acquisition layer, a BEI identity-anchor module, a MemoryChain event ledger, a TimeCurrency mint-trigger engine, a Retrochain forensic remediation module, a Relay Mesh communication module, and a domain-based endpoint resolver. These components are operatively integrated as a coordinated closed-loop workflow such that interruption or invalidity of identity anchoring, MemoryChain recording, mint-trigger generation, forensic remediation, or relay routing prevents completion of the sovereign time-value workflow.

The multimodal acquisition layer may receive physiological, behavioral, device-context, and environmental signals from a mobile device, wearable shell, sensor array, accessory, implant-assisted key, secure enclave, biometric interface, breath pattern interface, motion sensor, optical sensor, acoustic sensor, temperature sensor, electrodermal sensor, radar sensor, or proximity sensor.

The BEI identity-anchor module may bind an accepted event to a LIFE ID, BEI DID, BEIDID, BEIEID, account-bound credential, biometric template, local secure-enclave key, or implant-assisted identity key. The binding may be accompanied by liveness verification, quality codes, permission state, policy state, and terminal signature.

The MemoryChain event ledger may record cryptographic commitments instead of unnecessary raw personal data. A MemoryChain record may include an event identifier, BEI anchor reference, sensor commitment, time-window identifier, domain endpoint reference, policy identifier, acquisition-quality code, anti-replay value, prior record hash, terminal signature, and optional encrypted payload pointer.

The TimeCurrency mint-trigger engine may generate a mint certificate after verifying the MemoryChain record, BEI identity state, policy version, validity window, behavior category, acquisition quality, liveness state, and anti-replay state. The mint certificate may be transmitted to BEIMINT.com, TimeCurrency.app, BEICurrency.com, ATMS.com, BEI.app, or another non-limiting endpoint for validation, wallet update, accounting, settlement, or clearing.

The Retrochain forensic remediation module may detect anomalies such as signature mismatch, duplicate mint attempts, abnormal physiological signals, unauthorized terminal control, transaction inconsistency, policy violation, endpoint spoofing, Relay Mesh compromise, or device loss. In response, the module may generate a forensic remediation receipt and may trigger quarantine, freeze, rollback, restoration, or emergency notification according to policy.

The Relay Mesh communication module may route emergency, medical, security, identity, minting, remediation, or governance messages by device-to-device, device-to-gateway, or multi-hop routing when ordinary connectivity is unavailable, congested, censored, compromised, or degraded. Such routing may be prioritized according to urgency level, trust score, jurisdiction profile, endpoint signature, battery state, bandwidth condition, or medical/emergency state.

The domain-based endpoint resolver may resolve namespace basepoints such as ATMS.com, BEI.app, MF.app, 24HWS.com, 36JI.com, SZBF.com, BEIECO.com, BEISOS.com, BEIMINT.com, BEICurrency.com, BEIDID.com, BEIEDI.com, BEIEID.com, TimeCurrency.app, BEIGX.com, BEICX.com, BEISX.com, BEIIndex.com, BEISign.com, medicalcenter.us, 120.us, or other service nodes. The terminal verifies signed endpoint records before transmitting MemoryChain records, mint certificates, forensic receipts, Relay Mesh messages, signature-confirmation records, medical or emergency requests, or recovery requests. The coordinated closed-loop workflow constitutes a technical improvement in mobile terminal operation by providing edge-level, tamper-evident, identity-bound behavior-to-value conversion and forensic remediation that prior isolated wearable, wallet, or mesh systems could not achieve.

### Definitions

BEI: Behavioral Economics Identity or Behavioral Economics Index, referring to a computer-implemented identity, scoring, indexing, or authorization framework associated with a person, household, institution, device, or resource.

BEI Sovereign Mobile Terminal: A mobile, wearable, implant-assisted, or hybrid terminal configured to perform identity-bound behavior acquisition, MemoryChain recording, mint-trigger generation, forensic remediation, and Relay Mesh communication.

Coordinated closed-loop workflow: An operationally integrated sequence in which acquisition, identity anchoring, event recording, mint-trigger generation, forensic remediation, and relay communication are mutually referenced and verified so that a later stage depends on the integrity of an earlier stage.

MemoryChain: A tamper-evident event-recording structure storing cryptographic commitments, time windows, identity references, terminal signatures, policy identifiers, and links to prior or related event records.

TimeCurrency: A time-denominated value framework in which verified behavior or time-effort may generate mint-trigger certificates or value units according to policy constraints.

Mint certificate: A terminal-generated or system-generated certificate referencing a BEI identity anchor, MemoryChain record, behavior category, time window, policy version, anti-replay value, and mint amount or mint eligibility state.

Retrochain forensic remediation: A backward-traceable forensic workflow configured to identify an anomaly path and generate evidence, quarantine, freeze, rollback, release, restoration, or corrective receipts.

Relay Mesh: A device-to-device, device-to-gateway, or multi-hop communication network for emergency, security, identity, minting, governance, or recovery messages.

Domain-based namespace basepoint: A domain, subdomain, application domain, derived identifier, or equivalent namespace entry that resolves to signed endpoint records for service routing.

Signed endpoint record: A verifiable data object that maps a namespace basepoint to endpoint addresses, public keys, policy versions, validity windows, service categories, jurisdiction identifiers, routing priorities, or resource types.

Finite Execution Endpoint: a terminal-side execution point at which open-ended human behavior, identity state, time-window information, sensor data, emergency state, service routing, or value-related events are converted into bounded, verifiable, signed, policy-governed, and endpoint-routable records.

BEIFR2 Bounded Rollback and Clawback Framework: a BEI forced-and-fair forensic remediation framework in which freeze, quarantine, bounded rollback, clawback, release, restoration, core-state restoration, key revocation, credential recovery, or endpoint reauthorization actions are performed only within defined policy, validity-window, identity-authorization, evidence-snapshot, terminal-signature, and affected-asset boundaries.

Three-Anchor Signature Authorization: a signature or authorization structure in which an action is validated using at least two or more anchor categories selected from an identity anchor, terminal anchor, behavior-event anchor, policy anchor, endpoint anchor, time-window anchor, biometric anchor, secure-element anchor, or institutional anchor.

Terminal-Bank Gateway: an endpoint, service layer, or protocol interface through which a plurality of user terminals may submit identity-bound MemoryChain records, mint certificates, forensic remediation receipts, service-node records, or endpoint-routed value objects for wallet update, accounting, clearing, exchange, index publication, service authorization, or regulatory reporting.

Terminal-Based Service or Franchise Node: a user terminal, household terminal, merchant terminal, institutional terminal, wearable terminal, vehicle terminal, medical terminal, manufacturing terminal, retail terminal, or other edge terminal that functions as a policy-governed service node for identity verification, service discovery, behavior-value generation, mint-trigger submission, wallet interaction, clearing routing, index feedback, emergency routing, or local or remote service participation.

Hierarchical Time Namespace: a time-based namespace or identifier structure in which event records, mint certificates, policy windows, settlement windows, index periods, or validity intervals are organized according to time layers including, without limitation, hour, day, week, month, year, lifecycle, emergency period, policy-defined period, or resource-defined period.

Extensible Resource Layer: a namespace, endpoint, service-node, or asset-routing layer through which additional identity, medical, education, finance, manufacturing, household, retail, emergency, governance, currency, resource, or jurisdiction nodes may be registered, resolved, verified, routed, and governed without changing the core terminal-side closed-loop workflow.

### BRIEF DESCRIPTION OF THE DRAWINGS

FIG. 1 illustrates an overall BEI Sovereign Mobile Terminal coordinated closed-loop architecture.

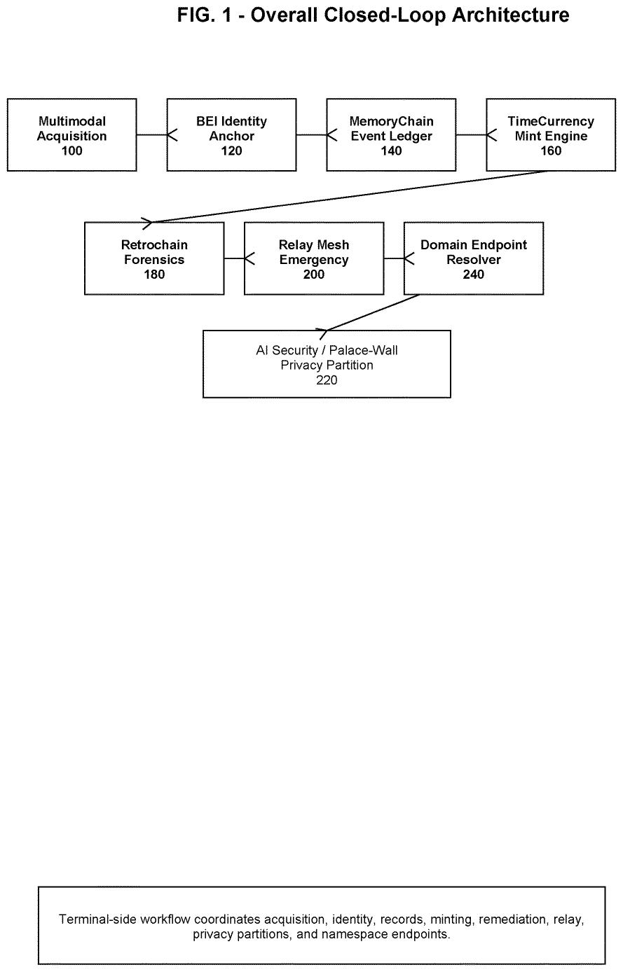

FIG. 2 illustrates a hardware integration stack including a mobile terminal body, wearable shell, sensor array, secure element, implant interface, power or NFC interface, feedback layer, and radio or relay interface.

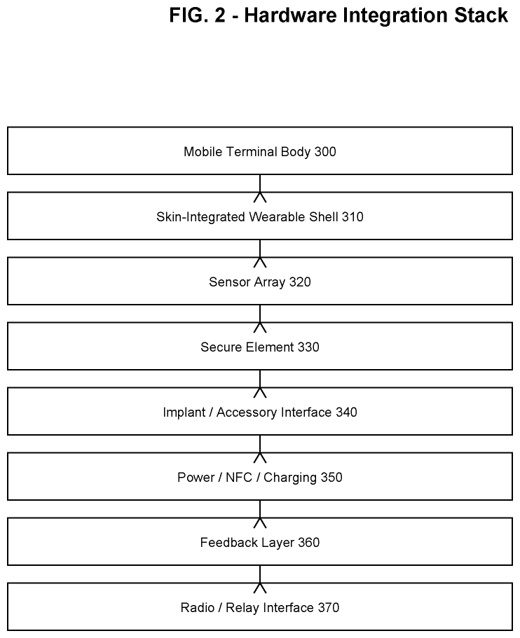

FIG. 3 illustrates multimodal acquisition and an event-quality gate including preprocessing, liveness, contact quality, replay checking, accepted events, and suppressed or degraded events.

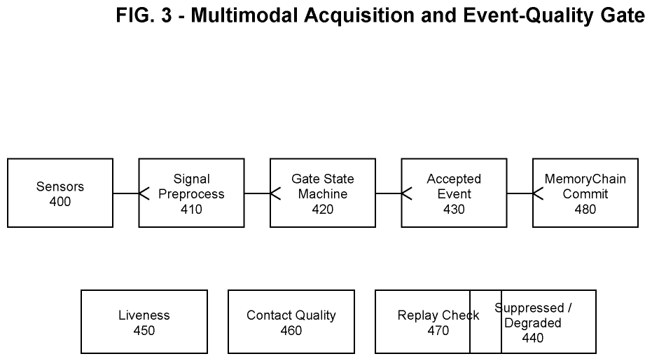

FIG. 4 illustrates BEI identity-anchor binding using BEI or LIFE ID, a terminal key, biometric template, implant key, identity-anchor engine, and anchor reference.

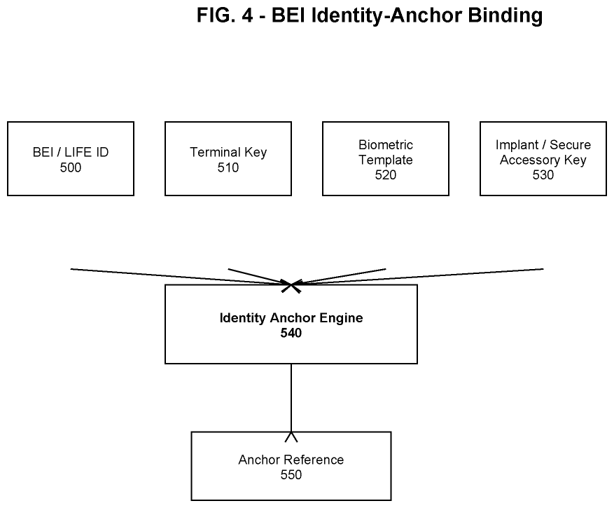

FIG. 5 illustrates a MemoryChain event record structure including time, event, quality, identity, sensor, context, policy, prior-record, mint-status, forensic-status, and signature fields.

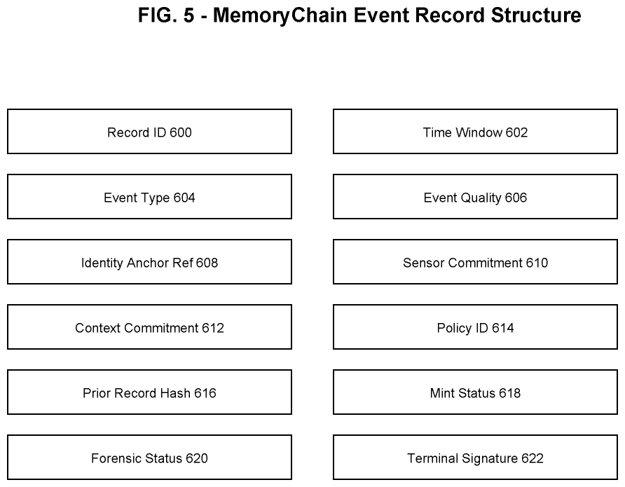

FIG. 6 illustrates a TimeCurrency atomic minting state machine including identity verification, policy checking, anti-replay checking, value computation, mint certificate generation, MemoryChain update, and dashboard or wallet output.

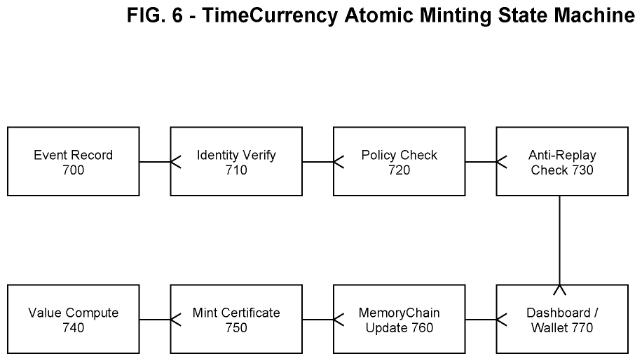

FIG. 7 illustrates Retrochain forensic tracing and remediation including monitoring, anomaly detection, evidence collection, causal-chain tracing, freeze, quarantine, rollback, restore, and corrective receipt functions.

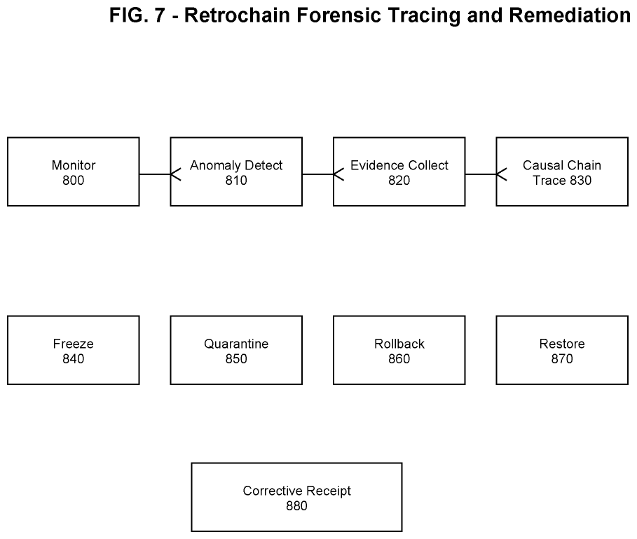

FIG. 8 illustrates Relay Mesh emergency communication among a terminal, peer devices, gateway nodes, medical or security nodes, and global 24HWS nodes.

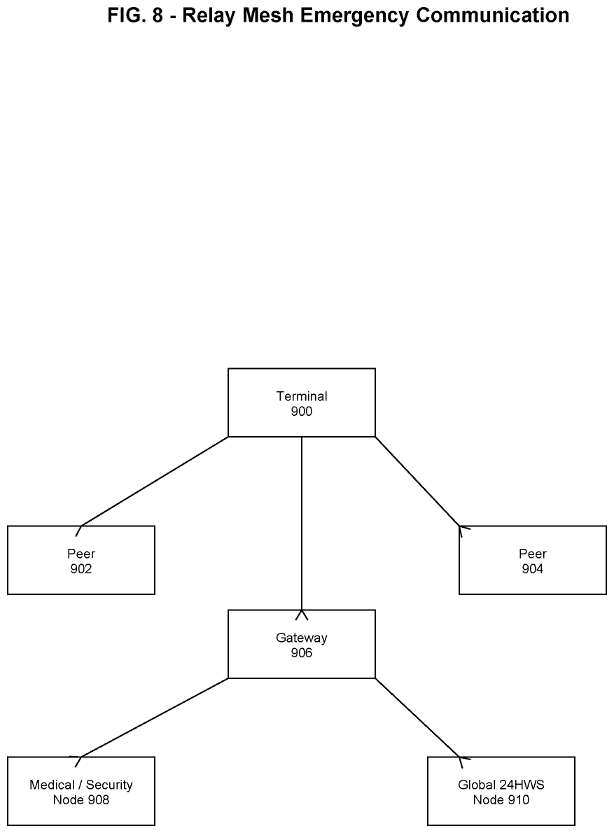

FIG. 9 illustrates an AI security and palace-wall privacy framework separating identity, medical, reproductive, financial, governance, emergency, and public partitions.

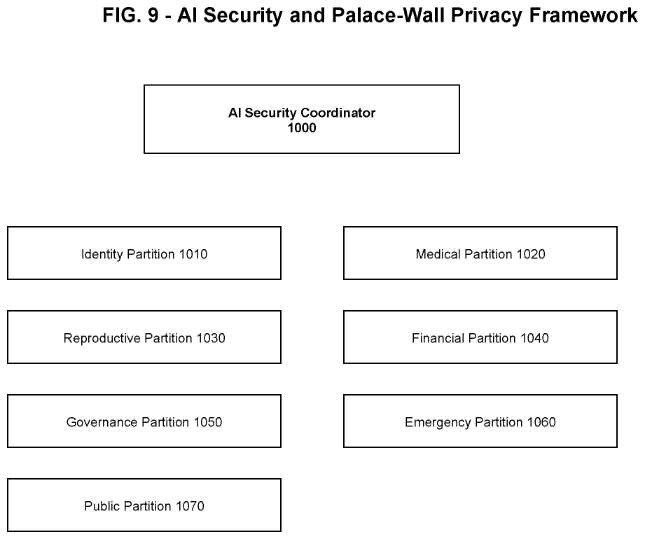

FIG. 10 illustrates an end-to-end closed-loop sequence including acquisition, gating, anchoring, recording, minting, monitoring, freeze or restore, and relay operations.

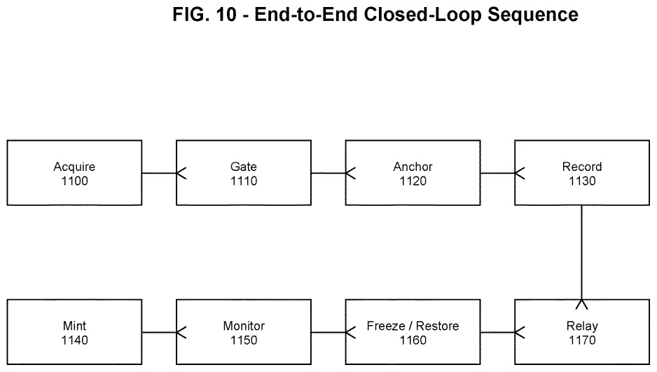

FIG. 11 illustrates a sovereign terminal dashboard showing BEI identity status, MemoryChain events, TimeCurrency balance, forensic alerts, Relay Mesh state, privacy-wall state, and governance controls.

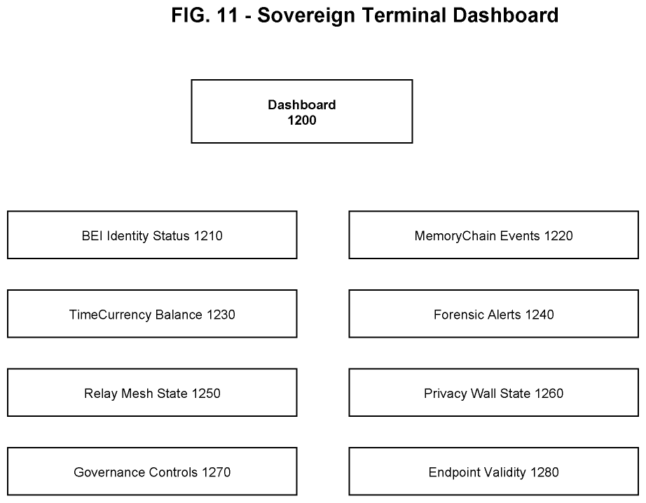

FIG. 12 illustrates BEI/24HWS ecosystem integration including identity, minting, ATMS, exchange, clearing, standards, DAO, 24HWS, namespace, signature, medical, emergency, index, and operating-system endpoints as non-limiting examples.

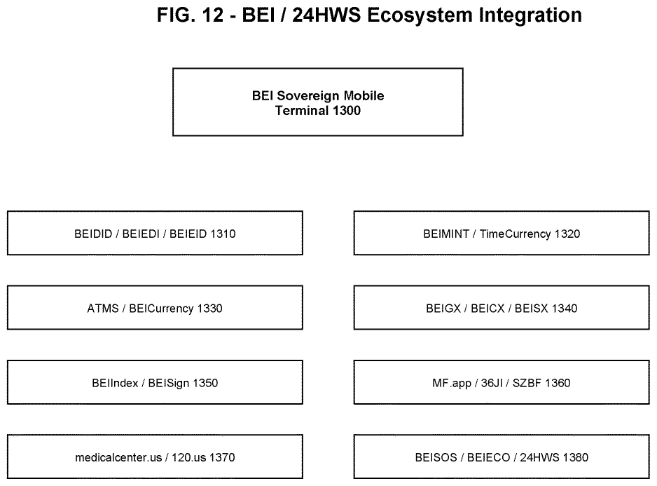

### DETAILED DESCRIPTION

### System Overview

In certain embodiments, the BEI Sovereign Mobile Terminal is implemented as a smartphone, wearable device, terminal phone, mobile wallet, secure tablet, body-area hub, wearable shell controller, implant-assisted security controller, or hybrid terminal. The terminal includes one or more processors, memories, sensors, secure keys, wireless interfaces, display interfaces, and software modules configured to execute the closed-loop workflow.

The terminal may operate locally, online, offline, or in a degraded network state. Local operation may include acquisition, identity verification, provisional MemoryChain commitments, local anti-replay tracking, and emergency alert preparation. Online operation may include endpoint resolution, signed policy retrieval, mint-trigger transmission, clearing, index publication, signature verification, medical or emergency routing, or synchronization with ATMS, BEIMINT, BEICurrency, BEIGX, BEICX, BEISX, BEIIndex, BEISign, BEIECO, BEISOS, MF, 24HWS, medicalcenter.us, 120.us, or related systems.

The terminal does not require any particular blockchain, mobile operating system, radio band, domain name, application store, identity standard, token standard, or government registry. The described domains and services are non-limiting examples of routable basepoints and ecosystem endpoints.

In certain embodiments, the BEI Sovereign Mobile Terminal functions as a finite execution endpoint for an otherwise distributed behavior-economy infrastructure, converting open-ended human behavior, time, identity, sensor data, emergency state, and service routing into bounded, verifiable, signed, policy-governed, and endpoint-routable records.

### Multimodal Acquisition Layer

The acquisition layer may receive signals from optical, acoustic, inertial, radar, proximity, temperature, electrodermal, electrocardiographic, photoplethysmographic, respiratory, camera, microphone, keyboard, touchscreen, geolocation, environmental, document, or accessory sensors. In some embodiments, the acquisition layer includes a skin-integrated wearable shell configured to maintain sensor contact and transmit quality-coded signals to the terminal.

Each acquired signal may be assigned an acquisition-quality code. Quality codes may represent contact quality, liveness, motion artifact level, signal-to-noise ratio, contamination risk, spoofing risk, device calibration state, privacy sensitivity, or emergency priority. The quality code may determine whether an event is eligible for MemoryChain recording, TimeCurrency mint-trigger generation, emergency routing, or forensic review.

The acquisition layer may support real-world scenarios including health monitoring, education attendance, work contribution, caregiving, charity, disaster response, emergency medical access, financial authorization, DAO participation, or resource-management workflows. These scenarios are examples and may be extended to numerous human needs, industries, currencies, resources, and policy categories.

### Acquisition Gate State Machine

The acquisition gate state machine provides a concrete technical mechanism for determining whether an acquired event can progress through the closed-loop workflow. A non-limiting state sequence may include: S0 idle; S1 signal acquisition; S2 quality assessment; S3 liveness verification; S4 BEI identity anchoring; S5 MemoryChain commitment; S6 mint eligibility check; S7 mint certificate generation; S8 forensic monitoring; S9 remediation or relay routing.

If a signal fails a quality threshold, the gate may suppress mint-trigger generation while still recording a low-quality event for audit or emergency purposes. If identity confidence fails, the gate may require additional biometric, credential, implant-assisted, or secure-enclave verification. If anti-replay verification fails, the gate may quarantine the event and trigger Retrochain review.

The gate state machine improves terminal operation by preventing unverified, duplicated, stale, spoofed, or policy-ineligible behavior records from becoming mint-trigger certificates. This technical gate is distinct from a mere business rule because it controls terminal signal processing, identity binding, MemoryChain commitment, cryptographic certificate generation, and remediation state transitions.

### Bei Identity Anchor Module

The BEI identity-anchor module binds accepted event data to a BEI identity anchor such as LIFE ID, BEIDID, BEIEID, BEI DID, account-bound token, biometric template, secure-enclave key, implant-assisted key, verifiable credential, or other non-transferable or controlled identity reference. The anchor may be represented by a public-key reference, cryptographic address, credential hash, or terminal-specific identity handle.

An implant-assisted identity key may be implemented as an optional micro-implant chip, secure accessory, near-field credential, or body-area device. The disclosure does not require implantation; the same function may be implemented by a secure wearable, hardware token, secure enclave, passkey, or equivalent identity anchor. This avoids limiting the invention to a single hardware form while preserving support for implant-assisted embodiments.

Identity anchoring may include multi-signature verification, revocation state, recovery key logic, emergency delegate authorization, medical emergency authorization, parental or family authorization, institutional authorization, or jurisdictional policy. Such authorization may be recorded in MemoryChain and reflected in mint certificates or forensic receipts.

### Memorychain Event Ledger

A MemoryChain record may be generated for an accepted event. In certain embodiments, the MemoryChain record includes fields: record_id, BEI_anchor_reference, terminal_id, sensor_commitment, event_category, behavior_category, time_window, domain_basepoint_reference, endpoint_record_hash, policy_id, quality_code, liveness_code, anti_replay_nonce, prior_record_hash, encrypted_payload_pointer, terminal_signature, and timestamp.

The MemoryChain event ledger may be implemented using a distributed ledger, permissioned ledger, append-only log, Merkle structure, local secure log, WORM storage, or hybrid on-chain/off-chain structure. In privacy-preserving embodiments, raw physiological data or personal data are not published; cryptographic commitments and encrypted pointers are recorded while selective disclosure occurs under policy.

MemoryChain records may support user dashboards, health records, education records, work records, caregiving records, charitable contribution records, resource records, contractual records, emergency records, or governance records. The terminal may generate local provisional MemoryChain commitments when offline and synchronize them to a selected endpoint after network restoration.

### Timecurrency Mint-Trigger Engine and Mint Certificate

The TimeCurrency mint-trigger engine is configured to determine whether a MemoryChain record is eligible to generate a mint certificate. The terminal may not itself be a central bank or final issuer; in some embodiments it generates a verified mint-trigger certificate that may be submitted to BEIMINT.com, TimeCurrency.app, BEICurrency.com, ATMS.com, BEI.app, or another endpoint for minting, accounting, wallet update, reserve treatment, clearing, or index publication.

A mint certificate may include fields: mint_certificate_id, BEI_anchor_reference, MemoryChain_record_hash, behavior_category, time_window, jurisdiction_code, domain_basepoint_reference, policy_version, quality_score, liveness_score, credit_multiplier, anti_replay_nonce, minted_amount_or_eligibility_state, terminal_signature, endpoint_record_hash, and forensic_status. This certificate provides a concrete data object for BEIMINT and BEICurrency workflows.

In one non-limiting embodiment, a mint amount may be derived from BaseRate, TimeEffort, QualityScore, IdentityConfidence, CreditMultiplier, RegionalFactor, ResourceFactor, and RiskAdjustment. The formula is illustrative; policy bundles may substitute jurisdiction-specific, industry-specific, household-specific, or resource-specific parameters. Minting may be denied, reduced, delayed, quarantined, or routed for review when the gate state machine or Retrochain module flags an issue.

In certain embodiments, the time-window identifier may correspond to a hierarchical time namespace, including an hour, day, week, month, year, lifecycle, emergency period, or policy-defined settlement window, so that terminal-generated MemoryChain records and mint certificates can be routed, aggregated, reconciled, or indexed across multiple time layers.

### Genesis Value Engine

The Genesis Value Engine may compute a behavior-credit score, mint eligibility, value-unit weight, or governance weight using MemoryChain records, time windows, behavior categories, acquisition quality, prior records, jurisdiction profiles, resource categories, and risk signals. It may support healthcare, education, work, caregiving, charity, disaster response, environmental, manufacturing, finance, family, or community-service categories.

The engine may generate a behavior-credit vector rather than a single score. Example vector dimensions include identity confidence, data quality, effort duration, social contribution, health relevance, emergency priority, resource scarcity, industry value, jurisdiction policy, and remediation risk. These dimensions allow the terminal to support many needs and industries without hard-coding a single economic rule.

The Genesis Value Engine may be implemented locally, remotely, or in hybrid form. Local logic may compute preliminary eligibility and privacy-preserving commitments. Remote logic may validate policy, reserve constraints, anti-fraud rules, or clearing requirements through signed endpoint records obtained from BEIMINT, BEICurrency, BEIINDEX, ATMS, BEIECO, BEISOS, BEIGX, BEICX, or BEISX endpoints.

### Retrochain Forensic Remediation Module

The Retrochain forensic remediation module is configured to trace backward from an anomaly to relevant MemoryChain records, mint certificates, identity anchors, endpoint records, terminal signatures, Relay Mesh messages, and policy states. The trace may identify a causal path, affected assets, duplicate records, compromised keys, spoofed endpoint records, excessive fatigue, severe emotional fluctuation, unauthorized transaction, malicious operation, or emergency distress.

A forensic remediation receipt may include receipt_id, original_mint_certificate_id, anomaly_type, evidence_snapshot_hash, affected_asset_reference, freeze_state, quarantine_state, restoration_state, arbitration_or_policy_reason, relay_notification_record, policy_version, timestamp, and terminal_or_endpoint_signature. Such receipts provide concrete evidentiary objects for audit, dispute resolution, insurance, medical response, family support, or regulatory review.

Remediation actions may include freeze, quarantine, release, rollback, restoration, key revocation, endpoint blocking, Relay Mesh notification, medical alert, family alert, governmental node notification, DAO review, or BEIGX/BEICX/BEISX clearing exception handling. The module may apply bounded remedies rather than arbitrary ledger editing, and it may record each remedy as a separate tamper-evident event.

In certain embodiments, the Retrochain forensic remediation module may implement a BEIFR2 bounded rollback and clawback framework. The framework may generate tamper-evident forensic receipts for freeze, quarantine, bounded rollback, clawback, release, core-state restoration, key revocation, credential recovery, or endpoint reauthorization actions. Each remediation action may be limited by a policy version, validity window, affected asset reference, identity-anchor authorization, terminal signature, and evidence snapshot, thereby preventing arbitrary ledger modification while enabling accountable correction of fraud, duplicate minting, terminal compromise, identity misuse, or emergency recovery events.

### Relay Mesh Emergency Communication Module

The Relay Mesh communication module provides a backup or complementary communication path when conventional mobile, internet, or application-level connectivity is degraded or unavailable. The terminal may route messages through nearby terminals, gateways, family nodes, volunteer nodes, medical nodes, government nodes, BEIECO nodes, ATMS nodes, or emergency endpoints.

Routing may be selected according to urgency level, endpoint signature, node trust score, user consent, medical emergency state, jurisdiction policy, battery state, bandwidth, proximity, route diversity, or safety threshold. Emergency messages may include physiological distress alerts, security compromise alerts, identity recovery requests, forensic remediation receipts, or mint-trigger quarantine notices.

The Relay Mesh may use point-to-point, ultra-short-range, local wireless, cellular, satellite, Wi-Fi, Bluetooth, NFC, mesh radio, or other communication technologies. The invention is not limited to a particular frequency band or radio protocol. The technical function is the terminal-side coordination of emergency routing with identity, MemoryChain, TimeCurrency, and Retrochain states.

In high-security implementations, the terminal may interoperate with SIM-less identity communication, multi-anchor signature authorization, dynamic switch-code access, post-quantum credential protection, privacy-preserving recovery systems, or mission-critical field communication endpoints. Such implementations may support government, financial, medical, disaster-response, defense-grade, or infrastructure-continuity contexts in which ordinary cellular connectivity, centralized account recovery, or SIM-based authentication is unavailable, compromised, or insufficient.

### Domain-Based Namespace Endpoint Layer

The terminal may resolve a domain-based namespace basepoint to obtain a signed endpoint record. Non-limiting examples include ATMS.com, BEI.app, MF.app, 24HWS.com, 36JI.com, SZBF.com, BEIECO.com, BEISOS.com, BEIMINT.com, BEICurrency.com, BEIDID.com, BEIEDI.com, BEIEID.com, TimeCurrency.app, BEIGX.com, BEICX.com, BEISX.com, BEIIndex.com, BEISign.com, BEIIP.com, medicalcenter.us, and 120.us. Other person, family, industry, country, region, currency, resource, legal, regulatory, signature, medical, emergency, or standards endpoints may be used.

In certain embodiments, an ATMS endpoint may operate as a terminal-bank gateway through which a plurality of BEI Sovereign Mobile Terminals submit identity-bound MemoryChain records, mint certificates, forensic remediation receipts, service-node records, and endpoint-routed value objects for wallet update, accounting, clearing, exchange, index publication, service authorization, or regulatory reporting.

In certain embodiments, the BEI Sovereign Mobile Terminal may operate as a terminal-based retail, service, or franchise node within a distributed BEI/ATMS ecosystem. A user terminal may function as a personal entry point for identity verification, service discovery, behavior-value generation, mint-trigger submission, wallet update, clearing, exchange routing, index publication, emergency routing, and local or remote service participation.

In certain implementations, the domain-based namespace layer may serve as an extensible resource layer through which new service nodes, retail nodes, franchise nodes, household nodes, industry nodes, medical nodes, education nodes, financial nodes, manufacturing nodes, emergency nodes, governance nodes, and jurisdiction nodes can be created, resolved, verified, and routed. Such an extensible resource layer allows the same terminal-side closed-loop workflow to support diverse human needs and service categories without requiring a separate hard-coded application for each category.

The namespace layer allows the terminal to adapt to many categories of human needs, industries, currencies, resources, and regulatory policies. For example, a health behavior event may route to a medical and BEIMINT endpoint; an emergency state may route to 120.us or medicalcenter.us; a currency event may route to BEICurrency.com or TimeCurrency.app; a clearing event may route to BEIGX.com, BEICX.com, or BEISX.com; an index event may route to BEIINDEX.com; and an operating-system or service orchestration event may route to BEISOS.com.

### BEI Operating System and Service Orchestration

In certain embodiments, BEISOS.com or another operating-system namespace may provide policies, service manifests, module registries, terminal update rules, endpoint discovery rules, certification profiles, or application routing logic for the BEI Sovereign Mobile Terminal. The terminal may verify an operating-system endpoint record before loading policy bundles, service catalogs, security updates, or terminal workflow updates.

The operating-system layer may orchestrate BEI identity, MemoryChain recording, TimeCurrency mint-trigger generation, Retrochain remediation, Relay Mesh routing, ATMS wallet interaction, BEIMINT validation, BEICurrency publication, BEIGX/BEICX/BEISX clearing, BEIINDEX scoring, and BEIECO dashboard synchronization. Such orchestration is optional and does not limit the core terminal-side closed-loop workflow.

### Privacy, Security, and Palace-Wall Partitioning

Sensitive data may be partitioned by role, purpose, category, and emergency state. A palace-wall privacy partition may separate reproductive health data, mental health data, medical test records, financial records, family records, education records, work records, and governance records. The term palace-wall is used as a descriptive name for layered privacy partitioning and does not require a particular brand or interface.

Encryption policies may include role-based encryption, threshold authorization, emergency break-glass authorization, family authorization, institutional authorization, medical authorization, and jurisdiction-specific access controls. The terminal may record each access, disclosure, emergency unlock, or denial as a MemoryChain event and may trigger Retrochain review if access is abnormal.

### Offline Synchronization and Conflict Handling

When the terminal is offline, it may cache event records, MemoryChain commitments, mint-trigger candidates, endpoint records, and emergency messages. The terminal may assign provisional status to locally generated records. Upon restoration of connectivity, the terminal may submit records to selected endpoints and receive validation, denial, adjustment, quarantine, or remediation commands.

If a duplicate or conflicting record is detected, the terminal may compare anti-replay nonces, time windows, endpoint signatures, terminal signatures, and prior MemoryChain hashes. Conflicts may be resolved by policy, quarantined for review, or linked to a forensic remediation receipt.

### Example Embodiment 1: Daily Behavior-to-Timecurrency Workflow

A user performs a verified education, work, healthcare, caregiving, or charitable action. The terminal acquires sensor and context signals, validates acquisition quality, anchors the event to BEI identity, records a MemoryChain commitment, generates a mint certificate, and transmits the certificate to a BEIMINT or TimeCurrency endpoint. The user's dashboard shows the pending or confirmed TimeCurrency state.

If the same behavior record is replayed, the anti-replay state rejects the duplicate. If the event is partially valid but low quality, the terminal may record the event without generating a mint certificate or may reduce the mint eligibility value. If an endpoint record is expired or unsigned, the terminal prevents transmission until a valid endpoint is obtained.

### Example Embodiment 2: Medical and Emergency Workflow

A physiological distress condition is detected from respiratory, heart-rate, temperature, motion, acoustic, optical, or electrodermal signals. The acquisition gate assigns emergency priority. The terminal records a MemoryChain emergency commitment, generates a relay message, and routes it through Relay Mesh to medicalcenter.us, 120.us, a family endpoint, a government endpoint, or a designated medical provider endpoint.

If the user has pre-authorized emergency access to selected medical, identity, or contact partitions, the terminal may unlock selected encrypted partitions under a break-glass policy, record the unlock as a MemoryChain event, and generate a forensic remediation receipt. The system thereby supports emergency response without requiring broad disclosure of all personal data.

### Example Embodiment 3: Fraud, Loss, and Restoration Workflow

If the terminal detects device loss, signature mismatch, abnormal transaction behavior, endpoint spoofing, or unauthorized access, Retrochain forensic remediation traces relevant MemoryChain records, endpoint records, and mint certificates. The terminal may generate a freeze receipt and route it to ATMS, BEIMINT, BEICurrency, BEIGX, BEICX, BEISX, BEIINDEX, or BEIECO endpoints.

When the user re-establishes identity through a recovery key, implant-assisted key, family authorization, secure enclave, or institutional credential, a restoration receipt may be generated. The receipt links to the original freeze receipt and identifies the basis for restoration. This supports accountable recovery rather than uncontrolled asset loss.

### Example Embodiment 4: Domain-Based Multi-Industry Routing

A terminal may classify an event as medical, education, manufacturing, finance, family, emergency, resource, governance, signature, identity, or legal. Based on the classification, the domain-based endpoint resolver selects a namespace basepoint. For example, ATMS.com may be selected for wallet or banking context, BEI.app for identity dashboard context, MF.app for mind, money, manufacturing, or multi-function context, 24HWS.com for time-value context, 36JI.com or SZBF.com for regional or institutional service context, BEIECO.com for ecosystem context, BEISOS.com for operating-system orchestration, BEIMINT.com for minting, BEICurrency.com for currency publication, BEIDID.com, BEIEDI.com, or BEIEID.com for identity or electronic/economic identity context, BEISign.com for signature or evidence-confirmation context, medicalcenter.us or 120.us for medical or emergency context, TimeCurrency.app for time-currency application functions, BEIGX.com, BEICX.com, or BEISX.com for exchange, clearing, or standards functions, and BEIIndex.com for index publication.

### Technical Advantages

The disclosed terminal provides a practical technical improvement over isolated mobile, wearable, wallet, and mesh systems by coordinating acquisition, identity, recording, mint-trigger generation, forensic remediation, and relay communication in a verifiable closed-loop workflow.

The acquisition gate state machine improves data quality and anti-spoofing. MemoryChain records improve auditability without forcing raw data publication. Mint certificates improve BEIMINT and TimeCurrency interoperability. Forensic remediation receipts improve accountable freeze and restoration. Relay Mesh routing improves emergency continuity. Domain-based endpoint records improve scalable service discovery across identity, currency, operating-system, exchange, clearing, index, and regulatory services. The coordinated closed-loop workflow constitutes a technical improvement in mobile terminal operation by providing edge-level, tamper-evident, identity-bound behavior-to-value conversion and forensic remediation that prior isolated wearable, wallet, or mesh systems could not achieve.

The coordinated closed-loop workflow constitutes a technical improvement in mobile terminal operation by converting raw local signals into identity-bound, policy-gated, anti-replay-protected, tamper-evident, and endpoint-routable value evidence before downstream minting, wallet, clearing, exchange, index, or service-node systems accept the event.

The foregoing definitions may be implemented as protocol-level terms for interoperability, certification, policy routing, audit, recovery, mint-trigger validation, terminal-bank operation, service-node expansion, or standards-based integration across related BEI/ATMS systems.

### INDUSTRIAL APPLICABILITY

The invention may be used in mobile devices, wearable systems, personal identity systems, health systems, emergency systems, digital wallets, time-banking platforms, behavior-credit systems, decentralized identity systems, operating-system service layers, token or currency systems, exchange and clearing systems, regulatory sandboxes, family-care systems, educational systems, manufacturing systems, and multi-industry BEI/ATMS/24HWS ecosystems.

The terminal can operate as a personal entry point for individuals, families, households, industries, institutions, countries, regions, currencies, resources, laws, standards, and policy profiles. These uses are non-limiting and may be implemented gradually through selected endpoints and service categories.

### Representative Data Structures

| Object | Representative fields | Purpose |
|---|---|---|
| MemoryChain | record_id; | Tamper-evident |
| record | BEI_anchor_reference; | event recording |
| | sensor_commitment; | |
| | time_window; policy_id; | |
| | quality_code; | |
| | anti_replay_nonce; | |
| | prior_record_hash; | |
| | terminal_signature | |
| Mint certificate | mint_certificate_id; | TimeCurrency/ |
| | MemoryChain_record_hash; | BEIMINT |
| | behavior_category; | mint-trigger |
| | policy_version; | |
| | minted_amount_or_eligibility; | |
| | terminal_signature; | |
| | forensic_status | |
| Forensic | receipt_id; anomaly_type; | Accountable freeze/ |
| remediation | evidence_snapshot_hash; | restoration |
| receipt | affected_asset_reference; | |
| | freeze_state; | |
| | restoration_state; | |
| | policy_reason | |
| Signed endpoint | basepoint; endpoint_type; | Domain-based |
| record | endpoint_address; | service routing |
| | public_key; | |
| | validity_window; | |
| | jurisdiction_code; | |
| | service_category; | |
| | routing_priority | |

### Representative Pseudocode

```
function processBehaviorEvent(signalBundle):
  quality = AcquisitionGate.assess(signalBundle)
  if quality == FAIL:
    MemoryChain.appendLowQualityCommitment(signalBundle)
    return NO_MINT
  anchor = BEIIdentityAnchor.verify(signalBundle.userCredential)
  if anchor == INVALID:
    Retrochain.quarantine(signalBundle)
    return IDENTITY_REVIEW
  record = MemoryChain.commit(signalBundle, anchor, quality)
  eligibility = TimeCurrencyEngine.checkEligibility(record)
  if eligibility.allowed:
    cert = TimeCurrencyEngine.issueMintCertificate(record, eligibility)
    EndpointRouter.submit(cert)
  Retrochain.monitor(record)
  return record.status
function resolveEndpoint(basepoint, serviceType, policyContext):
  endpointRecord = NamespaceResolver.lookup(basepoint, serviceType)
  if not verifySignature(endpointRecord):
    return BLOCKED_ENDPOINT
  if not within ValidityWindow(endpointRecord):
    return EXPIRED_ENDPOINT
  if not policyAllows(endpointRecord, policyContext):
    return POLICY_BLOCKED
  return endpointRecord.endpoint_address
```

### Extended Implementation Examples for Multi-Need, Multi-Industry, Multi-Currency, and Multi-Regulatory Use

The BEI Sovereign Mobile Terminal may be implemented in a manner that supports a broad range of human needs and industry categories while preserving the same terminal-side closed-loop workflow. The terminal does not need to contain separate hard-coded logic for each need or industry. Instead, it may map each behavior event to a behavior category, resource type, currency type, industry code, household identifier, jurisdiction profile, endpoint record, and policy version. This mapping allows the terminal to support large numbers of use cases through the same acquisition, identity anchoring, MemoryChain, mint certificate, Retrochain, Relay Mesh, and endpoint-routing structures.

In a healthcare implementation, the terminal may receive physiological signals such as respiration, temperature, motion, optical pulse, acoustic cough patterns, electrodermal responses, or medical-document commitments. The acquisition gate determines signal quality and liveness. The BEI identity anchor confirms the patient or caregiver identity. The MemoryChain record stores a commitment to the event and relevant time window. A mint certificate may represent verified care time, prevention time, recovery time, treatment adherence, emergency response contribution, or health-support contribution. Retrochain remediation may freeze a suspicious health-claim mint trigger or restore access after a verified medical correction. Relay Mesh may transmit emergency alerts through medicalcenter.us, 120.us, BEIECO, or other medical endpoints.

In an education implementation, the terminal may receive attendance, learning activity, assessment completion, reading time, certification, mentoring, or skill-practice events. The terminal may route education-related mint-trigger certificates to a TimeCurrency endpoint, BEIMINT endpoint, ATMS education account, or BEIINDEX education-scoring endpoint. The system may preserve privacy by recording only commitments to learning records while allowing selective disclosure to an institution, family, employer, or scholarship program.

In a work and manufacturing implementation, MF.app, 36JI.com, SZBF.com, or another manufacturing, mind, money, regional, institutional, or multi-function endpoint may provide a signed endpoint record defining activity categories, quality standards, safety rules, shift windows, output certifications, and resource identifiers. The terminal may generate MemoryChain commitments for verified work, machine-operation time, safety compliance, training time, maintenance contribution, or supply-chain quality events. A TimeCurrency mint certificate may represent verified productive time or safety-positive behavior, while Retrochain remediation may quarantine events associated with counterfeit credentials, compromised terminal keys, or duplicated work claims.

In a household and family implementation, the terminal may support caregiving, elder support, childcare, home safety, family budget participation, learning support, health-monitoring support, and emergency-contact workflows. A family endpoint record may identify authorized family delegates, emergency unlock rules, child or elder guardianship constraints, and privacy partitions. The terminal may allow a family member to generate a MemoryChain record for caregiving time without publicly exposing private medical details. In a distress condition, Relay Mesh may notify family nodes before or alongside medical or government endpoints according to policy.

In a country or regional implementation, a terminal may resolve jurisdiction-specific endpoint records defining local identity rules, emergency numbers, medical access policy, currency rules, clearing endpoints, data-residency constraints, or disaster-response protocols. Such rules may be encoded as signed policy identifiers and validity windows. The same terminal may operate across regions by switching endpoint records rather than changing the closed-loop workflow.

In a multi-currency implementation, the terminal may generate mint certificates or value-unit records that can be denominated in TimeCurrency, BEICurrency, TimeCoin, BEI units, loyalty units, care units, health units, education units, resource units, or other policy-defined value units. The terminal may route a certificate to BEICurrency.com, TimeCurrency.app, BEIMINT.com, ATMS.com, BEI.app, BEISign.com, or other currency, signature, verification, or accounting endpoints. The mint certificate may include currency type and resource type fields, allowing the clearing or wallet system to distinguish between different value families without changing terminal acquisition or identity logic.

In a clearing and exchange implementation, a verified mint certificate or remediation receipt may be transmitted to BEIGX.com, BEICX.com, BEISX.com, or another exchange, clearing, or standards endpoint. The terminal may not execute exchange clearing itself; instead, it provides terminal-originated evidence objects that downstream exchange or clearing systems can validate. This separation improves patent clarity by positioning the terminal as an entry, evidence, and trigger layer while related systems perform exchange, clearing, listing, index, or settlement functions.

In an index implementation, BEIIndex.com or a related index endpoint may receive privacy-preserving summaries or commitments derived from MemoryChain records and mint certificates. The index endpoint may compute behavior-value, health, education, contribution, risk, emergency-readiness, identity-confidence, or industry scores. The terminal may display these scores in a dashboard but does not require any single index formula. Index endpoints are optional examples of domain-based service routing.

In an operating-system implementation, BEISOS.com or another service orchestration basepoint may publish signed endpoint records identifying approved modules, policy bundles, terminal workflow updates, privacy partitions, security patches, and endpoint categories. The terminal may verify the BEISOS endpoint record before accepting a workflow update or policy update. This allows the terminal to participate in an operating-system-like BEI service layer without making any domain name required by the claims.

In an intellectual property and asset implementation, BEIIP.com or another IP endpoint may receive MemoryChain commitments relating to invention activity, document creation, patent filing tasks, licensing communications, or asset-package evidence. A terminal may generate a mint certificate for verified contribution time or a forensic receipt for evidence preservation. This can support patent-asset management without converting the terminal case into a separate NFT/DID/DAO patent.

In a terminal-bank implementation, ATMS.com or another terminal-bank gateway may receive terminal-originated MemoryChain records, mint certificates, forensic receipts, or service-node records and may coordinate wallet state, accounting state, eligibility state, clearing status, exchange routing, or index publication without requiring the terminal itself to operate as a central bank or clearinghouse.

In a retail or franchise implementation, a personal, household, merchant, institutional, or regional terminal may act as a service node that accepts service requests, validates identity, records behavior or service completion, issues or routes mint-trigger certificates, and receives index feedback or wallet updates. Such a node may support retail, caregiving, education, health, manufacturing, emergency, resource, or governance services while preserving the same terminal-side closed-loop workflow.

In a signature and privacy implementation, BEISign.com, BEIEDI.com, BEIEID.com, BEIDID.com, BIN3SIGN-related, SwitchCode-related, or equivalent identity-signature endpoints may provide multi-anchor signature authorization, dynamic access code verification, post-quantum credential protection, privacy-preserving recovery, or endpoint reauthorization for terminal actions.

The endpoint model is also useful for regulatory compatibility. A regulator, standards body, bank, insurer, medical institution, school, employer, exchange, clearinghouse, family office, or government node may publish endpoint records with validity windows and public keys. The terminal verifies those endpoint records before routing sensitive records or certificates. If an endpoint record expires or fails signature verification, the terminal blocks transmission and may generate a forensic event.

The closed-loop workflow may therefore serve many human needs and industry categories through a controlled technical interface. The invention does not require a separate custom claim for each field. The same technical structures-acquisition gate, identity anchor, MemoryChain, mint certificate, forensic remediation receipt, Relay Mesh, and signed endpoint record-support different categories through policy, endpoint, and data-structure variation.

### Technical Improvements Over Conventional Systems

The technical improvement provided by the terminal is not merely the use of a computer to perform economic activity. The terminal improves acquisition integrity, identity binding, event-record integrity, anti-replay protection, certificate generation, anomaly remediation, degraded-network routing, and endpoint verification. The terminal performs these operations at the edge, close to the user and sensors, before a downstream minting or clearing system accepts an event.

The acquisition gate state machine may improve mobile terminal operation by blocking low-quality, spoofed, stale, duplicated, or unanchored signal events. For example, a raw step-count value may be insufficient for a mint certificate. The terminal may require a liveness signal, device signature, time-window match, BEI identity confidence, and policy match before the record advances to mint eligibility. This concrete sequence improves the reliability of terminal-generated records.

The MemoryChain data structure may improve event-recording technology by linking sensor commitments, identity references, endpoint records, and policy identifiers in a tamper-evident chain. A downstream system can verify not only that a record exists, but also that the record was generated by a terminal with a valid identity anchor, within a validity window, under a specific policy version, and without replay.

The mint certificate may improve interoperability between terminal systems and minting systems by providing a standard data object. The terminal does not merely request a reward. It provides evidence fields that allow BEIMINT, TimeCurrency, BEICurrency, ATMS, BEIGX, BEICX, BEISX, BEIIndex, BEISign, MF, medical, emergency, or another endpoint to verify eligibility, risk, identity, time window, signature state, and replay status.

The forensic remediation receipt may improve recovery and audit technology by producing a separate, traceable evidence object when an anomaly occurs. Instead of silently deleting or reversing a transaction, the system can generate a receipt linking the original event, the anomaly, the evidence snapshot, the policy reason, and the remediation action. This is useful for users, families, institutions, insurers, regulators, and courts.

The Relay Mesh may improve emergency communication technology by linking emergency routing with identity, medical partitions, MemoryChain evidence, and remediation state. A generic mesh network may route messages, but the disclosed terminal routes messages that are bound to a terminal identity and event context. This allows emergency responders or authorized nodes to understand the source, urgency, and evidentiary context of the alert.

The domain endpoint layer may improve service discovery and policy routing by verifying signed endpoint records. A generic URL or application server may be spoofed or stale. The terminal verifies public keys, validity windows, service categories, jurisdiction codes, and policy identifiers before transmitting sensitive event records or certificates. This makes the terminal suitable for multi-region, multi-industry, multi-currency, and multi-resource deployment.

The combination is not a mere aggregation. Acquisition affects identity anchoring; identity anchoring affects MemoryChain validity; MemoryChain validity affects mint-trigger generation; mint certificates affect Retrochain monitoring; Retrochain status affects Relay Mesh emergency routing; endpoint records affect where the closed-loop outputs are sent. A failure or abnormality in one stage changes the state or output of another stage.

The terminal also provides a finite execution point for distributed behavior-value infrastructure. Open-ended life events, sensor streams, service participation, emergency states, and identity actions are not left as unbounded data fragments; they are reduced at the edge into signed, bounded, policy-governed, auditable, and remediable evidence objects that can be accepted by downstream BEI/ATMS systems.

The terminal can be implemented incrementally. A first implementation may use only smartphone sensors and BEI.app identity. A second implementation may add a wearable shell. A third implementation may add an implant-assisted or secure accessory key. A fourth implementation may add TimeCurrency mint certificates. A fifth implementation may add Retrochain remediation and Relay Mesh. Each implementation remains within the same technical architecture.

In certain embodiments, the disclosed terminal definitions and data objects may serve as a standards-oriented interface among mobile terminals, wallets, healthcare systems, emergency systems, retail or franchise nodes, banking gateways, minting engines, clearing endpoints, exchange endpoints, index endpoints, and regulatory endpoints. Such standards-oriented use is non-limiting and does not require any particular standards body, domain name, blockchain, radio protocol, or operating system.

What is claimed is:

1. A BEI Sovereign Mobile Terminal system comprising:
(a) a multimodal acquisition layer configured to acquire physiological, behavioral, device-context, or environmental signals associated with a user;
(b) a BEI identity-anchor module configured to bind an accepted event derived from the signals to a BEI identity anchor;
(c) a MemoryChain event ledger configured to generate a tamper-evident event record including a cryptographic commitment to the accepted event, a time-window identifier, and a terminal signature;
(d) a TimeCurrency mint-trigger engine configured to verify a policy state and anti-replay state of the tamper-evident event record and to generate a mint certificate for a time-denominated value unit;
(e) a Retrochain forensic remediation module configured to detect an anomaly associated with at least one of the accepted event, the BEI identity anchor, the MemoryChain event ledger, or the mint certificate and to generate a forensic remediation receipt for quarantine, freeze, rollback, release, or restoration;
(f) a Relay Mesh communication module configured to route emergency, security, identity, minting, remediation, or recovery messages through device-to-device, device-to-gateway, or multi-hop routing when ordinary connectivity is unavailable or degraded; and
(g) a domain-based endpoint resolver configured to resolve a namespace basepoint to a signed endpoint record for identity, minting, currency, clearing, exchange, index, signature, standards, emergency, governance, operating-system, medical, or regulatory service routing,
wherein the multimodal acquisition layer, BEI identity-anchor module, MemoryChain event ledger, TimeCurrency mint-trigger engine, Retrochain forensic remediation module, Relay Mesh communication module, and domain-based endpoint resolver are operatively integrated as a coordinated closed-loop workflow such that failure of identity anchoring, event recording, mint-trigger generation, forensic remediation, or relay routing prevents completion of a sovereign time-value workflow within a single terminal.

2. A computer-implemented method performed by a BEI Sovereign Mobile Terminal, comprising:
(a) acquiring, by a multimodal acquisition layer of the terminal, physiological, behavioral, device-context, or environmental signals associated with a user;
(b) validating the signals using an acquisition gate state machine that evaluates acquisition quality, liveness, identity confidence, and policy eligibility;
(c) binding an accepted event derived from the signals to a BEI identity anchor;
(d) writing a cryptographic commitment of the accepted event to a MemoryChain event record;
(e) verifying a policy state, validity window, and anti-replay state of the MemoryChain event record;
(f) generating a mint certificate for a time-denominated value unit when the accepted event satisfies the policy state, validity window, and anti-replay state;
(g) detecting an anomaly associated with the accepted event, BEI identity anchor, MemoryChain event record, or mint certificate;
(h) generating a forensic remediation receipt for quarantine, freeze, rollback, release, or restoration in response to the anomaly; and
(i) routing an emergency, security, identity, minting, remediation, or recovery message through a Relay Mesh communication module when a degraded-network or emergency condition is satisfied.

3. A non-transitory computer-readable medium storing instructions that, when executed by one or more processors of a mobile terminal, cause the mobile terminal to perform operations comprising:
acquiring multimodal physiological or behavioral signals;
validating the signals using an acquisition gate state machine;
binding an accepted event to a BEI identity anchor;
generating a MemoryChain event record;
generating a TimeCurrency mint certificate after verification of policy and anti-replay states;
generating a Retrochain forensic remediation receipt when an anomaly is detected;
routing emergency or recovery communications through a Relay Mesh module; and
resolving a domain-based namespace basepoint to a signed endpoint record for identity, minting, currency, clearing, exchange, index, signature, standards, operating-system, emergency, medical, governance, or regulatory service routing.

4. The system of claim 1, wherein the multimodal acquisition layer includes a skin-integrated wearable shell configured to maintain sensor contact and transmit at least one acquisition-quality code to the terminal.

5. The system of claim 1, wherein the BEI identity-anchor module includes an implant-assisted identity key, secure enclave key, biometric template, account-bound credential, BEIDID, BEIEDI, BEIEID, LIFE ID, or verifiable credential.

6. The method of claim 2, wherein the acquisition gate state machine includes states for signal acquisition, quality assessment, liveness verification, identity anchoring, MemoryChain commitment, mint eligibility checking, mint certificate generation, forensic monitoring, and remediation or relay routing.

7. The system of claim 1, wherein the MemoryChain event record includes an event identifier, BEI anchor reference, sensor commitment, time-window identifier, domain basepoint reference, policy identifier, acquisition-quality code, anti-replay value, prior record hash, and terminal signature.

8. The system of claim 1, wherein the mint certificate includes a mint certificate identifier, BEI anchor reference, MemoryChain record hash, behavior category, time-window identifier, policy version, quality score, anti-replay nonce, mint amount or eligibility state, terminal signature, and forensic status.

9. The method of claim 2, wherein a TimeCurrency mint-trigger value is derived from at least one of time effort, acquisition quality, identity confidence, behavior category, regional factor, resource factor, credit multiplier, or risk adjustment.

10. The system of claim 1, wherein the Retrochain forensic remediation module generates the forensic remediation receipt including an original mint certificate reference, anomaly type, evidence snapshot hash, affected asset reference, freeze state, quarantine state, restoration state, policy reason, and relay notification record.

11. The method of claim 2, wherein the anomaly comprises a signature mismatch, duplicate mint attempt, stale validity window, endpoint spoofing event, unauthorized transaction, terminal compromise, abnormal physiological signal, or emergency distress condition.

12. The system of claim 1, wherein the Relay Mesh communication module selects a route according to urgency level, node trust score, endpoint signature, proximity, bandwidth, battery condition, jurisdiction policy, or emergency state.

13. The system of claim 1, wherein the namespace basepoint comprises a resolvable domain, subdomain, application-domain identifier, service namespace, country or regional namespace, medical or emergency namespace, identity namespace, operating-system namespace, exchange or clearing namespace, index namespace, signature namespace, standards namespace, or signed derived identifier that is verified by the domain-based endpoint resolver without requiring any particular domain name.

14. The system of claim 1, wherein the signed endpoint record identifies at least one of an identity endpoint, minting endpoint, currency endpoint, clearing endpoint, exchange endpoint, index endpoint, signature endpoint, standards endpoint, operating-system endpoint, emergency endpoint, medical endpoint, governance endpoint, or regulatory endpoint.

15. The method of claim 2, further comprising selecting the namespace basepoint according to at least one of a behavior category, time window, currency type, resource type, user role, industry code, household identifier, jurisdiction identifier, endpoint validity window, or emergency state.

16. The non-transitory computer-readable medium of claim 3, wherein the instructions cause the mobile terminal to cache a provisional MemoryChain event record while offline and synchronize the provisional MemoryChain event record with a selected endpoint after network connectivity is restored.

17. The non-transitory computer-readable medium of claim 3, wherein the instructions cause the mobile terminal to quarantine a mint certificate candidate when a duplicate anti-replay value, expired endpoint record, invalid endpoint signature, or policy conflict is detected.

18. The system of claim 1, further comprising a layered privacy partition configured to separate medical, reproductive-health, mental-health, financial, family, education, work, governance, and emergency data categories according to role-based or emergency-access authorization rules.

19. The method of claim 2, wherein an emergency mode unlocks a selected encrypted medical or identity partition, records the unlock as a MemoryChain event, generates a forensic remediation receipt, and routes an emergency message through the Relay Mesh communication module.

20. The non-transitory computer-readable medium of claim 3, wherein the instructions cause the mobile terminal to display a sovereign terminal dashboard showing BEI identity status, MemoryChain records, TimeCurrency mint certificates, forensic remediation receipts, Relay Mesh state, endpoint validity, and emergency mode status.
